(19) United States
(12) Patent Application Publication
(10) Pub. No.: US 2024/0362317 A1
(43) Pub. Date: Oct. 31, 2024

(54) CONFIDENTIAL CODE TRANSPARENCY SERVICE

(71) Applicant: Microsoft Technology Licensing, LLC, Redmond, WA (US)

(72) Inventors: Bryan David KELLY, Carnation, WA (US); Mark Eugene RUSSINOVICH, Bellevue, WA (US)

(73) Assignee: Microsoft Technology Licensing, LLC, Redmond, WA (US)

(21) Appl. No.: 18/307,627

(22) Filed: Apr. 26, 2023

(51) Int. Cl. G06F 21/44; G06F 8/71

(52) U.S. Cl. CPC G06F 21/44; G06F 8/71

(57) ABSTRACT

Examples relating to implementations of a confidential code execution environment for a code transparency service are provided. In one aspect, a computing system is provided, the computing system comprising a processor and a storage device containing instructions that, when executed, cause the processor to receive code data from a producer, store a code identity artifact comprising the code data on a ledger, wherein the ledger is updatable by an authorized party, receive a code identity endorsement from an auditor for the stored code identity artifact, and store a code identity endorsement artifact on the ledger based on the received endorsement from the auditor, wherein the code identity endorsement artifact is associated with the stored code identity artifact.

### BACKGROUND

Confidential computing refers to cloud computing technology that can isolate and protect data within a hardware-based environment, such as a protected central processing unit (CPU), while it is being processed. The data is isolated from unauthorized access and invisible to any program or person, including other applications and processes within the cloud system and the cloud provider/operator of the hardware-based environment. Access to the data is provided only to specially authorized programming code.

The isolation and protection of data in a cloud computing environment attempts to solve various vulnerabilities. For example, unencrypted data during computations can be accessed by unintended parties, such as a compromised cloud computing operator with admin privileges. Confidential computing fixes this and other issues by using a hardware-based architecture referred to as a trusted execution environment (TEE). A TEE is an environment that enforces execution of only authorized code, typically through the use of attestation mechanisms. This allows sensitive data to stay protected while in memory. When an application tells the TEE to decrypt the data, it is released for processing. While the data is decrypted during computations, it is invisible to everything and everyone else outside the TEE, including the cloud operator.

### SUMMARY

Examples relating to implementations of a confidential code execution environment for a code transparency service are provided. In one aspect, a computing system is provided, the computing system comprising a processor and a storage device containing instructions that, when executed, cause the processor to receive code data from a producer, store a code identity artifact comprising the code data on a ledger, wherein the ledger is updatable by an authorized party, receive a code identity endorsement from an auditor for the stored code identity artifact, and store a code identity endorsement artifact on the ledger based on the received endorsement from the auditor, wherein the code identity endorsement artifact is associated with the stored code identity artifact.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example confidential computing model for implementing a CTS instance with a confidential ledger for providing immutable records of code and configurations.

FIG. 2 shows an example confidential computing model for implementing a CTS instance with a confidential code review service, which is a variant of the confidential computing model illustrated in FIG. 1.

FIG. 3 shows an example confidential ledger where an artifact for a confidential service is stored, which is a ledger that can be implemented in the confidential computing models illustrated in FIGS. 1 and 2.

FIG. 4 shows an example verification process in which a relying party verifies a CTS instance's suitability, which is a process that can be implemented in the confidential computing models illustrated in FIGS. 1 and 2.

FIG. 5 shows a flow diagram for a method of implementing a confidential code execution environment for a code transparency service, which can include the code transparency service instances illustrated in FIGS. 1 and 2 according to one example.

FIG. 6 shows a schematic view of an example computing environment that can enact the services described and illustrated in FIGS. 1 and 2.

### DETAILED DESCRIPTION

Confidential computing technologies provide protection and security for various applications, including data security and code integrity. For example, an application where a user running workloads on a cloud server typically involves giving trust to various providers, such as software and hardware vendors, to enable different components of the user's applications. A confidential computing model lessens the need for this trust. Confidential computing refers to the protection of data in use associated with computations in a hardware-based confidential compute execution environment, such as a trusted execution environment. A TEE is an environment that enforces execution of only authorized code. Data in the TEE cannot be read or tampered with by code outside that environment. In some applications, the confidential computing model aims at removing or reducing the ability for a cloud provider operator and other actors in the user's domain to access code and data while being executed.

Confidential compute relies on the transparency of a confidential trust boundary (CTB), which describes the code and security properties for establishing trust in a confidential compute execution environment. Defining the separation of CTB and non-CTB code enables protection mechanisms for isolating code and data in the CTB from access by code outside of the CTB. Some confidential compute technologies reduce the size of the CTB by strongly isolating virtual machines (VMs) and containers from the underlying hypervisor such that the hypervisor code cannot access VM memory or compromise the integrity of the VM execution state.

Confidential compute technologies are built on various general design promises for the CTB that hold true across confidential architectures. Code, data, and execution state associated with a TEE are cryptographically protected to prevent disclosure of secrets outside the CTB of the TEE and are immune from interference from outside the CTB, except for in some cases signaling paths (e.g., interrupts, data exchange, etc.) expressly defined by the underlying architecture. Another design principle includes ensuring that code and the isolation mechanisms for establishing and preserving the CTB of a TEE are cryptographically measured and made available for inspection.

CTB code transparency includes three distinct categories of transparency mechanisms: open source, publishing, and third-party audit. Open source involves a public repository with licensing that restricts how the software can be used and modified. Publishing involves making the source code publicly available for review and offers users the ability to reproduce a build and make cryptographic verifications of code in their CTB. Different from public domain or open-source materials, publishing is provided and viewable primarily for the purpose of transparency. Publishing does not allow commits back into the project, and there are no license grants to use, copy, or modify the software. Publishing makes broad disclosures of the CTB code and might be prohibitive in circumstances where intellectual property is at issue, such as when trade secrets might be disclosed if the CTB code were to be published. In such cases, third-party audit mechanisms can be used when publishing is prohibitive. In third-party audit models, auditable software is not published, but is instead made available to third-party auditors for review. An auditor can operate on behalf of a customer/user or a collective group of such, providing an attestation of review of the auditable software.

Although third-party auditing models provide assurance and consistency to the users, managing auditable software can have a higher total cost of ownership (TCO) to the producers (e.g., hardware manufacturers) as it can involve access controls, audit logs, repeated auditor payments, or repeated escrow payments, etc. To control perpetual costs, third-party auditing should be for minimal CTBs where components change infrequently and code is highly re-used from other audited components. In other cases, it can be TCO prohibitive to audit large CTBs without component consistency, particularly if those components change frequently.

In view of the considerations above, the present disclosure provides for confidential code execution environments for implementing a code transparency service (CTS). A CTS can be implemented to provide guarantees on confidential policy compliance, substantially reducing the cost of systematic code review in various ways. In some implementations, the CTS is designed to offer irrefutable audits of all code and changes within a CTB by providing records for all CTB components irrespective of the publication or auditing transparency mechanism. For example, the CTS can include immutable records of the code and configurations relevant to enforcing confidentiality such that these records can be audited, source code inspected, and builds reproduced.

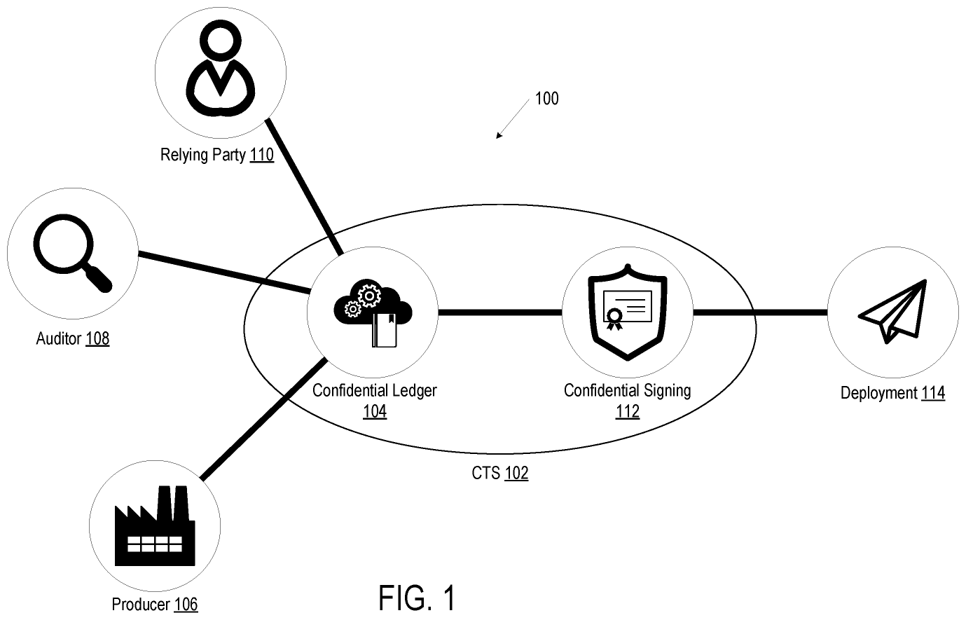

FIG. 1 shows an example confidential computing model 100 for implementing a CTS instance 102 with a confidential ledger 104 for providing immutable records of code and configurations. The confidential computing model 100 involves several actors, including a producer 106, an auditor 108, and a relying party 110. The producer 106 is an entity that provides code to be managed by the operator 108. In some implementations, the producer 106 pushes the code data to a repository, and code data provided to the CTS instance 102 is pulled from said repository. The producer 106 can include various types of entities. For example, the producer 106 can be a third-party hardware/software manufacturer that deploys firmware/software updates to fix issues and provide new functionalities on their distributed products. In some implementations, the producer 106 provides new code builds for first-party hardware/software. During the updates, new binary code builds are typically pushed to users of the products. However, deployment of a new code build introduces underlying security problems as the user's trust in the security of the old code is not extended to the new code. As such, the user or customer of the CTS (referred to herein as the relying party) relies on the auditor 108 to provide an independent assessment of the new code build.

The code data from the producer 106 is provided to the CTS instance 102 and stored on the confidential ledger 104 as an artifact. The confidential ledger 104 is implemented as an immutable ledger in which an authorized party has the ability to update. An artifact stored on the confidential ledger 104 includes a collection of evidence for a specific binary that is to be evaluated. The evidence can include claims about the code, build process, review signed by various parties, references to source code, and/or actual source code. For example, the code data can be stored as a code identity artifact that includes the source code or references to source code to be evaluated. Different types of artifacts and other entries can be recorded on the central ledger 102. Example entries can include an entry describing the CTS public key and node history. The CTS instance 102 can be implemented to log its signed public keys to a central ledger along with the proof that it has access to the previous private key. In some implementations, the CTS instance 102 logs all nodes that are or have been in the network, including their attestation reports, code identity, and public keys. Another example type of entry includes an entry describing that the CTS instance 102 has been authorized based on an auditor's endorsements.

The entries in the confidential ledger 104 may be used and relied upon by various entities in their respective evaluation of new code data. For example, the auditor 108 can review and audit an artifact recorded on the confidential ledger 104 that is to be endorsed. Based on attestations by the auditor 108, an endorsement artifact can be recorded for the artifact that was audited. As a more specific example, when the producer 106 pushes a new code build, the new code data can be recorded on the confidential ledger 104 as a code identity artifact containing or describing the code data.

The auditor 108 audits the code identity artifact and provides attestations based on their review and audit of the code identity artifact. Once the code identity gains the auditor's endorsement, a code identity endorsement artifact can be recorded on the confidential ledger 104, where the code identity endorsement artifact is associated with the code identity artifact to which it endorses. In some implementations, a confidential signing service (CSS) 112 is implemented to sign a binary if the artifact for that binary satisfies a predetermined set of policies, allowing the relying party 110 to trust said binary for deployment 114.

The CTS instance 102 can be implemented with multiple relying parties 110 and/or multiple auditors 108. The auditor 108 may be an auditor that is authorized by the relying party 110 or an auditor authorized by the CTS instance 102. In some implementations, the CTS instance 102 includes multiple auditors 108. For example, the CTS instance 102 can utilize a single universally accepted auditor or multiple auditors, each authorized by a different relying party 110. Multiple CTS instances can also be provided for different applications. For example, a global CTS instance that implements widely accepted policies and CTS instances that implement policies specific to a relying party or group of relying parties can be provided.

The auditor 108 can be implemented in various ways. In some implementations, the auditor 108 provides a manual review of the code data to ensure that the code data meets a predetermined set of policies, such as meeting specific security criteria. In other implementations, the auditor 108 reviews the code data using an automated method, such as through the use of machine learning (ML) and artificial intelligence (AI) models. Language models can provide a comprehensive view of code, and the use of AI and machine learning can substantially reduce the cost of manual and systematic code review. A combination of manual and automatic code review can also be performed. For example, the auditor 108 can review a portion of the code data using a code review machine learning model in a first pass, and the remaining portion can be reviewed through manual review in a second pass.

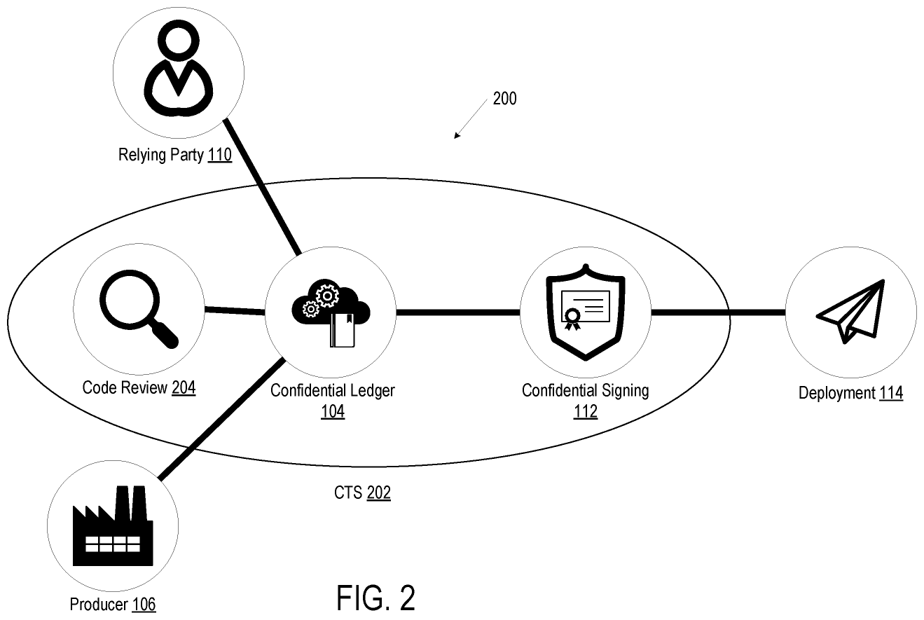

Use of ML and/or AI models can enable different confidential computing models. FIG. 2 shows an example confidential computing model 200 for implementing a CTS instance 202 with a confidential code review service 204. The confidential code review service 204 can be implemented as an auditor that uses an ML model and/or AI model that can certify/endorse code and changes, providing meaningful attestation regarding code coverage and review. Such implementations allow for a lower TCO by eliminating or reducing third-party auditor reviews. By making the auditing service autonomous and removing the service operator from the trust boundary, the confidential computing model 200 provides for a separation of operations and governance to create a sovereign service for auditing code. Additionally, the confidential code review service 204 implementing automated code reviews can provide auditing that is instant, continuous, and retrospective (e.g., as the model parameters advance with new learning). A combination of automated and manual code review can also be implemented. For example, an AI model can be implemented to perform a first pass audit, finding specific areas for a manual auditor to check.

Various types of artifacts can be stored on a confidential ledger for the evaluation of a binary. For example, as described above, the central ledger 102 can include a code identity artifact that includes the code data (e.g., source code or references to source code) to be evaluated. An endorsement artifact can be recorded, which represents a signature by an auditor on an artifact indicating that the auditor has endorsed claims in the artifact and optionally implemented their own reviews. An acceptance policy artifact includes statements about what policies a CTS enforces before signing an artifact. Statements are typically references to the public keys of auditors including metadata. In some implementations, acceptance policies apply to a CTS instance and can be updated by the same parties that authorized the previous policy. CTS signs artifacts when they comply with policies enforced by a CTS and the artifact at that point is CTS-authorized. Another type of artifact includes a usage policy artifact, which includes statements about how other artifacts should be used. Usage policies can be decentralized. For example, the author of a container image may have a usage policy for that container image to inform consumers which versions have security vulnerabilities. In some implementations, a confidential service operator/provider may have a usage policy that indicates to users what CTS evidence they should require to establish trust in that confidential service.

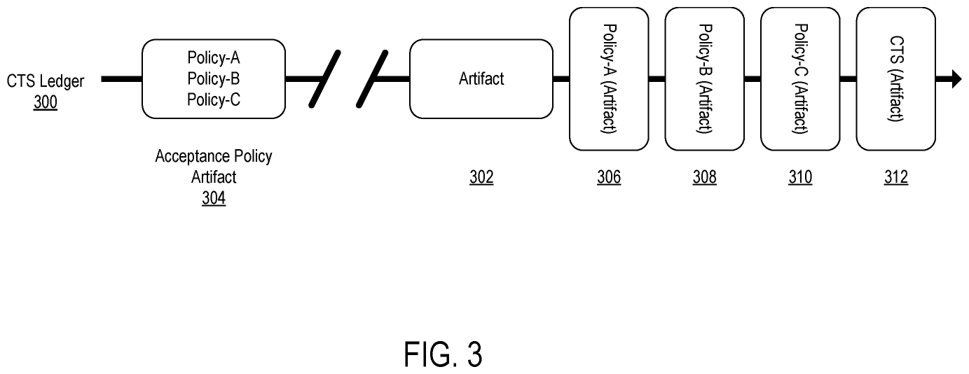

FIG. 3 shows an example confidential ledger 300 where an artifact 302 for a confidential service is stored. The confidential ledger 300 includes the artifact 302 and an acceptance policy artifact 304 that includes statements about what policies are enforced before the artifact is signed and authorized. In the depicted example, the acceptance policy artifact 304 describes three policies: Policy-A, Policy-B, and Policy-C. The confidential ledger 300 includes endorsement artifacts 306-310 that respectively correspond to the policies described in the acceptance policy artifact 304. Each endorsement artifact 306-310 represents an endorsement of the artifact 302 by an auditor. Once all required policy endorsements are present (such as the case of FIG. 3), a CTS authorization 312 approving the artifact 302 is recorded on the ledger 300. To prevent tampering, the ledger 300 is implemented as an immutable ledger in which an authorized party has the ability to update. Furthermore, the CTS can be implemented with protocols that enable proof of its misbehavior to provide greater assurances to a relying party.

A relying party should be able to enlist the use of a CTS that is approved by them or a party that they trust for their confidential service instances. For example, a relying party can require that their approved auditor has reviewed the CTS code identity and acceptance policy artifacts. Approval of a CTS instance can be demonstrated by the party endorsing the two artifacts and is referred to as CTS authorization. When a relying party wishes to verify a CTS instance's suitability, it can obtain a CTS receipt for the CTS authorization produced by their auditor. This proves that the CTS instance has been bootstrapped and authorized by an approved auditor. The verification can be performed offline.

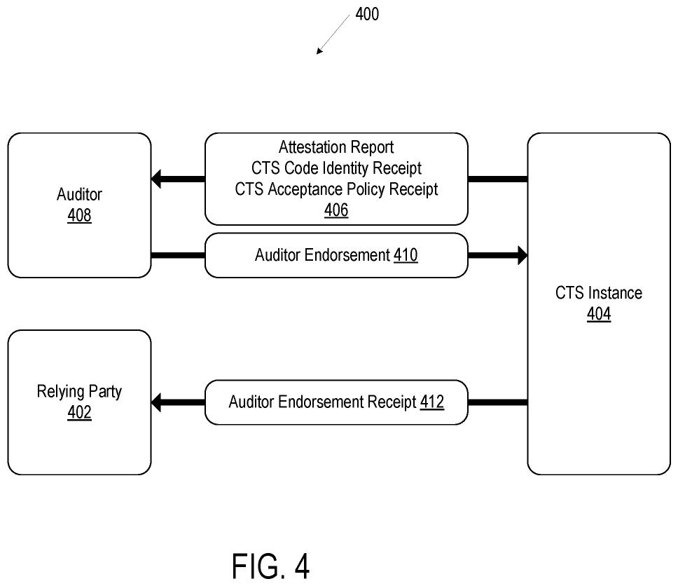

FIG. 4 shows an example verification process 400 in which a relying party 402 verifies a CTS instance's suitability. The process 400 starts with the CTS instance 404 providing various artifacts 406 to the auditor 408 to be endorsed. The auditor 408 is an auditor that has been approved by the relying party 402. In the depicted example, the CTS instance 404 provides an attestation report, a CTS code identity receipt, and a CTS acceptance policy receipt. The auditor 408 verifies these artifacts and sends back an endorsement 410 with the auditor's signature to the CTS instance. The relying party 402 can then retrieve an endorsement receipt 412 for verification of the CTS instance 404, which shows that the CTS instance has been verified by an auditor that was approved by the relying party 402.

A relying party can also verify that a confidential service is compliant with CTS policy by checking that its artifact is on the ledger of a CTS instance they trust and signed by that instance. This can be done by verifying a receipt for the CTS artifact, which can be performed offline. Fine grain verification can be performed by examining specific claims in the CTS artifact corresponding to the code. Similarly, specific claims in the auditor's signatures for a policy artifact can also be examined. For example, a relying party may want to verify that the confidential services were built using specific tools or environments or have undergone a specific audit.

Using CTS, confidential services can be upgraded where the new version complies with CTS policy. In some implementations, the upgrade process is performed in an automated fashion. While the upgrade process supports re-authorization of CTS upgrades where auditors perform manual inspections, the process also supports automated upgrades that guarantee that upgraded CTS code also complies with the policies enforced by the CTS. Policies like reproducible build and archiving to locations outside the control of the cloud provider can provide strong guarantees, such as guaranteed auditability. The upgrade process includes launching a new instance of the service side-by-side with a currently active one. The active instance is instructed to transfer its secrets to the new instance, at which point the active instance checks to see if the new instance is CTS-authorized. If the new instance is CTS-authorized, the new instance complies with CTS policies. The active instance rotates its signing key and then shares the updated key with the new instance. This prevents the new instance from signing artifacts using the identity of an older instance. The new instance then rotates its key, deauthorizing the previous instance. Key rollover and instance upgrades can be recorded in the CTS ledger, and a relying party can obtain a receipt for the CTS artifact that recorded the upgrade and verify it. In the automated flow, when a new node is added to a CTS instance, a CTS artifact for the code identity of the new node should be present on the ledger. Only nodes that match the most recent code identity are accepted.

If the failure threshold is exceeded for a given CTS instance, the instance can no longer reach consensus and disaster recovery can be performed. Because CTS holds integrity-protected data but not confidential data, creating a new CTS instance from another instance's ledger (or a prefix of that ledger) can be done without requiring key release. However, this admits a fork attack where the operator creates a forked CTS. In such cases, some transactions go to the fork, and then the fork is torn down. When disaster recovery uses the same code identity as the previous CTS instance, fork protection and seamless service identity can be provided by a stateful sealing service-e.g., a sealing service with a monotonic counter. Brownout protection can be provided with local sealing, which allows seamless disaster recovery when the hardware for at least one node survives. If disaster recovery requires a new code identity (i.e., the disaster was due to a bug that prevents the old code version from parsing the ledger), the CTS instance can be reauthorized.

CTS serves as a confidential environment root of trust that can guarantee to a user that confidential services comply with CTS policies, which includes that it has an artifact saved immutably to the ledger. A user's confidential computing environment is itself defined by its own keys where security-sensitive users will require that the root of their keys are stored in hardware security modules (HSMs) that are in compliance with the federal information processing standards (FIPS). As such, the CTS provides a user with a way to provision their HSM partition in a way that does not grant access to those keys to any non-compliant code.

In the case of managed HSM (MHSM), the MHSM front end (referred herein as MHSM) must have the password to use HSM keys. As such, a user can verify that MHSM is CTS-authorized before trusting it to protect access to an HSM partition. To do this, the MSHM can hardcode (meaning that it must include a TEE attestation measurement) the HSM partition bootstrap code, generation of HSM passwords, and validation of HSM certificates. Audits of the code can verify that MHSM will not accept externally generated passwords and that it will only share passwords with authentic HSM devices.

When a user creates an HSM partition, various artifacts can be provided for review. In some implementations, the artifacts include at least one or more of the HSM partition security domain, the MHSM's CTS artifact, the raw MHSM enclave attestation, the MHSM instance public key, CTS's CTS artifact, or the CTS instance public key. The user can validate that the MHSM and CTS artifacts are on the CTS ledger it is bound to and that the CTS code is a direct descendant of a version reviewed and approved by its auditors. They can also validate that the HSM is authentic. If these validations succeed, the client approves the HSM partition and begins using the MHSM. Upgrades can be performed similarly as upgrades for a general confidential service, where a new instance launches, the active instance is asked to share its key, and the active instance performs a CTS validation of the new instance before doing so.

The process described above assures a user that the MSHM meets CTS policies. The user can achieve additional confidence in the trustworthy behavior of the MHSM by checking for endorsements of the MHSM, either in the current instance or a version that the current one is derived from, by their auditors. As can readily be appreciated, the MHSM design described herein can be used to provide key operations backed by devices other than HSM's, such as other TEE-based key sealing implementations.

Establishing trust in a confidential service includes first establishing trust in a CTS. Because a relying party of a confidential service is configured with a CTS to trust, this will typically be an out-of-band validation that includes obtaining a CTS endorsement artifact from a trusted endorser, which can include the CTS signing key, the CTS code artifact, and the CTS policy artifact. For example, a relying party can obtain its endorsement from a well-known endpoint (e.g., a web endpoint), validates the endorsing signature, and then trusts the endorsed CTS signing key. The relying party does not need to trust the distribution mechanism.

Because the CTS signing key that a CTS uses to sign the artifact of a running version may not be the current CTS signing key (for example, because the key has been rotated), a relying party may need to update its view of the CTS signing key. To do so, the signed chain of keys from the endorsed key through to the one used to sign the current version artifact can be presented to the relying party. Once the keys are validated, the relying party is assured that the current CTS instance descended from an endorsed instance. This identity lineage can be published via any mechanism or provided out-of-band, and the relying party need not trust the distribution mechanism. At this point, trust in the CTS instance is established and clients of the relying party can be configured with the CTS network address and public key.

To validate a confidential service, a relying party can be presented with one or more CTS artifacts for the service. For example, presenting a single CTS artifact can be sufficient for a MHSM while a confidential pod may need to present CTS artifacts for the utility VM and for each container in the pod. The confidential service can present a hardware attestation report to the relying party that is linked to the CTS artifacts. For example, the code measurement can be sufficient for a MHSM (and must match the code measurement in the corresponding CTS artifact) while a confidential pod can require the code measurement to match the utility VM CTS artifact and the security policy to match the container CTS artifacts. The relying party validates the hardware attestation reports and the correspondence to the CTS artifacts. Because hardware validations can be cumbersome and do not provide rich claims that may be derived from trusted code, relying parties can, at the time they initialize, validate an attestation service and from that point forward rely on the attestation service to perform CTS validations and provide tokens that include additional claims it can chose to validate.

For some use cases (e.g., L0 firmware), a relying party can require signatures instead of CTS Artifact receipts. A confidential signing service that signs a binary if and only if it is given a CTS Artifact receipt for that binary allows a relying party that trusts that CSS to treat the signed binary as authoritative. The CSS itself can be CTS authorized on the same CTS instance for which it signs. The CSS can use a MHSM for key management and to perform signing operations. The MHSM security key release policy for the CSS signing key accepts CTS-authorized CSS instances.

A CTS can be implemented with varying degrees of guarantees. One classification involves three different levels of guarantees, each building on the previous. The three levels include policy compliance, misbehavior detection, and auditability. For example, a confidential service can be provided where the policies that the CTS enforces is not specified beyond that it ensures that artifacts of some type are on the ledger for anything CTS signs and that policy extensions have endorsed the artifacts. Such implementations satisfy the first level guarantee of confidential code policy compliance. In some cases, customers require stronger assurances. For example, a customer might like assurance that they can detect and prove that policy compliance is violated. Guarantees beyond policy compliance can be implemented by a CTS that has a reproducible build policy. Such a policy can be implemented by having a reproducible build service (RBS) that has been endorsed by auditors as such, and that it itself has its reproducible build artifacts registered in the CTS. The policy entry identifies the RBS via a well-known identifier that is backed by a secret known only to the reproducible build service. For an artifact to meet the reproducible build policy, the CTS should include an endorsement from the current version, as represented by entries in the CTS of the RBS and its public keys. The requirement of an RBS for CTS authorization of CTS itself does not introduce a circular dependency, because CTS will not sign its own artifacts until they adhere with its own policy.

To avoid having to include artifacts for all software dependencies used to produce confidential services, the artifacts can include only the contents for those that are not reviewed by parties trusted by the customer. For those that are reviewed by such parties, signatures can be included instead. For example, the build can use compilers and linkers that are from independent software vendors.

As part of a CTS bootstrap, the artifacts for CTS are stored on the ledger. When a reproducible build policy is in effect, the RBS will also have an artifact on the ledger with its own endorsement. After all authorizer endorsements for CTS and the RBS are on the ledger, which includes RBS endorsement of CTS, CTS signs the reproducible build artifact and its own artifact, completing CTS authorization.

The inclusion of an RBS enables implementations of CTS instances with guaranteed misbehavior detection. If a customer shows a CTS-signed attestation of a service for which artifacts are unavailable, the upgrade design for confidential services proves lineage and guarantees that any violation of policy will be evident in the CTS ledger, providing guarantee of misbehavior detection. Misbehaving implementations will be auditable if they are on the ledger since it will be possible to reproducibly build them, and the only reason one will not be on the ledger is that the ledger has been truncated or the build artifacts are withheld, which are themselves evidence of misbehavior.

Guaranteed auditability can be implemented by having a copy of the ledger and reproducible build artifacts be archived outside of the control of the CTS operator. This can be achieved by having a CTS auditor sign artifacts only after they have been archived in a public location or by a party trusted by the customer. For example, they could be published on a public ledger or source code repository, or they can be stored by a service operated by a trusted party in another cloud or on-premises environment. CTS can be implemented to not authorize an artifact until it has an endorsement from an archiving service. When an archiving service has archived an artifact, it signs its endorsement on CTS, guaranteeing that a customer can gain access to the code of any confidential service deployed into their environment. For fully automated CTS instances, a similar verified publication mechanism can precede CTS update authorization. This publication can provide additional traceability of all automated CTS updates by creating additional evidence of the update outside of the CTS service operator's control.

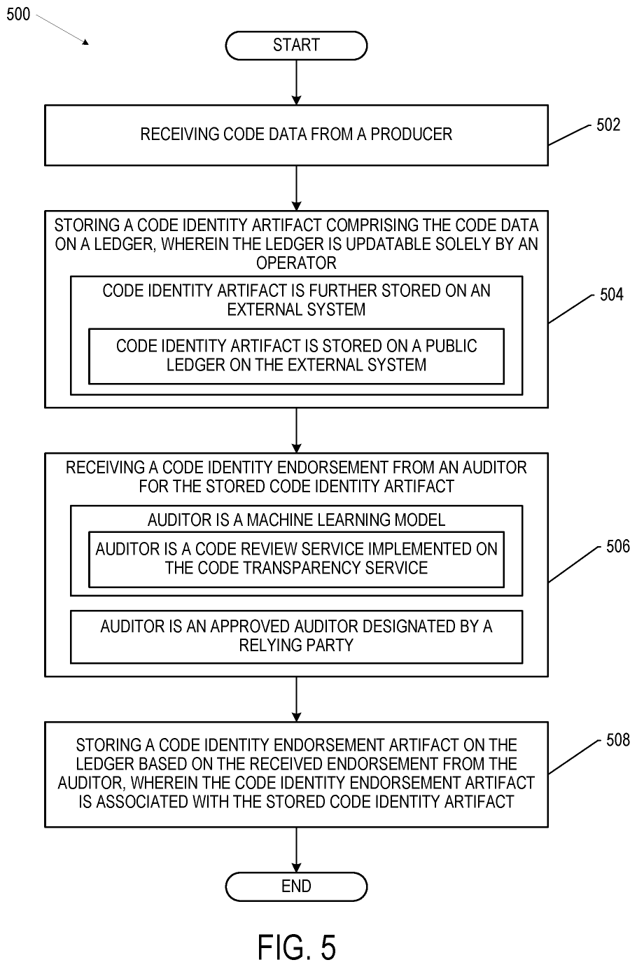

FIG. 5 shows a flow diagram for a method 500 of implementing a confidential code execution environment for a code transparency service. At step 502, the method 500 includes receiving code data from a producer. The code data can be source code, binary code, or any other information regarding code that a relying party wishes to evaluate before deployment. The producer can be any entity that provides such code data. For example, the producer can be a third-party hardware/software manufacturer that deploys firmware/software updates to fix issues and provide new functionalities on their distributed products. In some implementations, the producer is a repository that contains the code data, where the manufacturer uploads said code data to the repository. In further implementations, the code data is reviewed by an auditor approved by the manufacturer before it is uploaded to the repository.

At step 504, the method 500 includes storing a code identity artifact comprising the code data on a ledger. To avoid tampering, the ledger is updatable by an authorized party. A code identity artifact can include various information regarding the code data. For example, the code identity artifact can include references to binary/source code and/or actual binary/source code. Other artifacts and entries can also be stored on the ledger.

In some implementations, a copy of the ledger is archived on an external system. In such cases, a copy of the code identity artifact can be stored on the copy of the ledger. The external system can be outside of the control of the CTS operator. For example, the external archive can be a public ledger or a source code repository. The external system can be a service operated by an entity that is trusted by the relying party. CTS can be implemented to not authorize an artifact until it has an endorsement from an archiving service. When an archiving service has archived an artifact, it signs its endorsement on the CTS, guaranteeing that a customer can gain access to the code of any confidential service deployed into their environment.

At step 506, the method 500 includes receiving a code identity endorsement from an auditor for the stored code identity artifact. The auditor can include various entities. For example, the auditor can be an approved auditor designated by a relying party. The auditor can provide a review of the code identity artifact to ensure that the underlying code data meets a predetermined set of policies, such as meeting specific security criteria. In some implementations, the CTS is utilized by more than one relying party. In such cases, the CTS can utilize a single universally accepted auditor or multiple auditors, each authorized by a different relying party or group of relying parties.

In some implementations, the review is performed manually by a person. In other implementations, the auditor is an automated code review service. For example, the code review service can be a machine learning model or an AI code review model capable of automating the code review process. The code review service can be implemented externally or provided as an auditor module within the TEE of the CTS. A combination of manual and automatic code review can also be performed. For example, the code review service can review a portion of the code data using a code review machine learning model in a first pass, and the remaining portion can be reviewed through manual review in a second pass.

At step 508, the method 500 includes storing a code identity endorsement artifact on the ledger based on the received endorsement from the auditor. The code identity endorsement artifact is stored and associated with the code identity artifact. In some implementations, a copy of the code identity endorsement artifact is further stored on an external system, such as on a public ledger or code repository.

Confidential computing that implements a CTS as described herein can be provided to relying parties as a cloud service that reduces the TCO of auditable software compared to current methods. For example, implementations involving the use of a code review AI or ML model that is within the TEE of the CTS can eliminate the reoccurring costs associated with having an auditor perform manual reviews each time new code is to be deployed. In addition to the implementations described above, alternative or additional aspects can also be provided. For example, in some implementations, the method 500 further includes storing a reproducible build service artifact associated with the code identity artifact. The reproducible build service artifact can include information that allows a relying party to reproduce the code build. In such cases, a reproducible build service endorsement can be received from the auditor and stored on the ledger. Use of a reproducible build service enables a CTS with stronger assurances for the relying party. Additionally, with the use of an archival service such as a public ledger or code repository, the CTS can provide guaranteed auditability.

In some embodiments, the methods and processes described herein may be tied to a computing system of one or more computing devices. In particular, such methods and processes may be implemented as a computer-application program or service, an application-programming interface (API), a library, and/or other computer-program product.

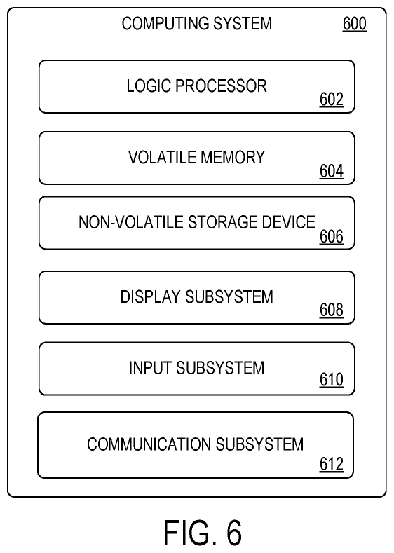

FIG. 6 schematically shows a non-limiting embodiment of a computing system 600 that can enact one or more of the methods and processes described above. Computing system 600 is shown in simplified form. Computing system 600 may embody a computer device that implements the services described and illustrated in FIGS. 1 and 2. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 602 may include one or more physical processors (hardware) configured to execute software instructions. Additionally or alternatively, the logic processor 602 may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor 602 optionally may be distributed among two or more separate devices, which may be remotely located and/or configured for coordinated processing. Aspects of the logic processor 602 may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built-in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program-and application-specific integrated circuits (PASIC/ASICs), program—and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local-or wide-area network, such as a HDMI over Wi-Fi connection. In some embodiments, the communication subsystem may allow computing system 600 to send and/or receive messages to and/or from other devices via a network such as the Internet.

The following paragraphs provide additional support for the claims of the subject application. One aspect provides a computing system for implementing a confidential code execution environment for a code transparency service, the computing system comprising a processor and a storage device containing instructions that, when executed, cause the processor to receive code data from a producer, store a code identity artifact comprising the code data on a ledger, wherein the ledger is updatable by an authorized party, receive a code identity endorsement from an auditor for the stored code identity artifact, and store a code identity endorsement artifact on the ledger based on the received endorsement from the auditor, wherein the code identity endorsement artifact is associated with the stored code identity artifact. In this aspect, additionally or alternatively, the auditor reviews the code data using a machine learning model to provide the code identity endorsement. In this aspect, additionally or alternatively, the machine learning model reviews portions of the code data, and wherein remaining portions are reviewed manually. In this aspect, additionally or alternatively, the machine learning model is implemented on the computing system. In this aspect, additionally or alternatively, the auditor is an approved auditor designated by a relying party. In this aspect, additionally or alternatively, the instructions further cause the processor to receive a verification request from a relying party and transmit a receipt of the received endorsement to the relying party. In this aspect, additionally or alternatively, the instructions further cause the processor to store a reproducible build service artifact associated with the code identity artifact, receive a reproducible build service endorsement from the auditor, and store a reproducible build service endorsement artifact on the ledger, wherein the reproducible build service endorsement artifact is associated with the reproducible build service artifact. In this aspect, additionally or alternatively, the instructions further cause the processor to, before receiving the code identity endorsement, transmit instructions for storing the code identity artifact on an external system. In this aspect, additionally or alternatively, the code identity artifact is stored on a public ledger on the external system. In this aspect, additionally or alternatively, the external system is operated by a party designated by a relying party.

Another aspect provides a method for implementing a confidential code execution environment for a code transparency service, the method comprising receiving code data from a producer, storing a code identity artifact comprising the code data on a ledger, wherein the ledger is updatable by an authorized party, receiving a code identity endorsement from an auditor for the stored code identity artifact, and storing a code identity endorsement artifact on the ledger based on the received endorsement from the auditor, wherein the code identity endorsement artifact is associated with the stored code identity artifact. In this aspect, additionally or alternatively, the auditor reviews the code data using a machine learning model to provide the code identity endorsement. In this aspect, additionally or alternatively, the machine learning model reviews portions of the code data, and wherein remaining portions are reviewed manually. In this aspect, additionally or alternatively, the machine learning model and the ledger are implemented on a computing system. In this aspect, additionally or alternatively, the auditor is an approved auditor designated by a relying party. In this aspect, additionally or alternatively, the method further comprises receiving a verification request from a relying party and transmitting a receipt of the received endorsement to the relying party. In this aspect, additionally or alternatively, the method further comprises storing a reproducible build service artifact associated with the code identity artifact, receiving a reproducible build service endorsement from the auditor, and storing a reproducible build service endorsement artifact on the ledger, wherein the reproducible build service endorsement artifact is associated with the reproducible build service artifact. In this aspect, additionally or alternatively, the method further comprises, before receiving the code identity endorsement, transmitting instructions for storing the code identity artifact on an external system. In this aspect, additionally or alternatively, the code identity artifact is stored on a public ledger on the external system.

Another aspect provides a computing system for implementing a confidential code execution environment for a code transparency service, the computing system comprising a set of processors and a set of storage devices storing a ledger, an auditor module comprising a code review machine learning model, and instructions that, when executed, cause the set of processors to receive code data from a producer, store a code identity artifact comprising the code data on a ledger, wherein the ledger is updatable by an authorized party, review the code data using the code review machine learning model, receive a code identity endorsement from the auditor module for the stored code identity artifact, and store a code identity endorsement artifact on the ledger based on the received endorsement from the auditor module, wherein the code identity endorsement artifact is associated with the stored code identity artifact.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein. as well as any and all equivalents thereof.

1. A computing system for implementing a confidential code execution environment for a code transparency service, the computing system comprising:
a processor and a storage device containing instructions that, when executed, cause the processor to:
receive code data from a producer;
store a code identity artifact comprising the code data on a ledger, wherein the ledger is updatable by an authorized party;
receive a code identity endorsement from an auditor for the stored code identity artifact; and
store a code identity endorsement artifact on the ledger based on the received endorsement from the auditor, wherein the code identity endorsement artifact is associated with the stored code identity artifact.

2. The computing system of claim 1, wherein the auditor reviews the code data using a machine learning model to provide the code identity endorsement.

3. The computing system of claim 2, wherein the machine learning model reviews portions of the code data, and wherein remaining portions are reviewed manually.

4. The computing system of claim 2, wherein the machine learning model is implemented on the computing system.

5. The computing system of claim 1, wherein the auditor is an approved auditor designated by a relying party.

6. The computing system of claim 1, wherein the instructions further cause the processor to:
receive a verification request from a relying party; and
transmit a receipt of the received endorsement to the relying party.

7. The computing system of claim 1, wherein the instructions further cause the processor to:
store a reproducible build service artifact associated with the code identity artifact;
receive a reproducible build service endorsement from the auditor; and
store a reproducible build service endorsement artifact on the ledger, wherein the reproducible build service endorsement artifact is associated with the reproducible build service artifact.

8. The computing system of claim 1, wherein the instructions further cause the processor to, before receiving the code identity endorsement, transmit instructions for storing the code identity artifact on an external system.

9. The computing system of claim 8, wherein the code identity artifact is stored on a public ledger on the external system.

10. The computing system of claim 8, wherein the external system is operated by a party designated by a relying party.

11. A method for implementing a confidential code execution environment for a code transparency service, the method comprising:
receiving code data from a producer;
storing a code identity artifact comprising the code data on a ledger, wherein the ledger is updatable by an authorized party;
receiving a code identity endorsement from an auditor for the stored code identity artifact; and
storing a code identity endorsement artifact on the ledger based on the received endorsement from the auditor, wherein the code identity endorsement artifact is associated with the stored code identity artifact.

12. The method of claim 11, wherein the auditor reviews the code data using a machine learning model to provide the code identity endorsement.

13. The method of claim 12, wherein the machine learning model reviews portions of the code data, and wherein remaining portions are reviewed manually.

14. The method of claim 12, wherein the machine learning model and the ledger are implemented on a computing system.

15. The method of claim 11, wherein the auditor is an approved auditor designated by a relying party.

16. The method of claim 11, further comprising:
receiving a verification request from a relying party; and
transmitting a receipt of the received endorsement to the relying party.

17. The method of claim 12, further comprising:
storing a reproducible build service artifact associated with the code identity artifact;
receiving a reproducible build service endorsement from the auditor; and
storing a reproducible build service endorsement artifact on the ledger, wherein the reproducible build service endorsement artifact is associated with the reproducible build service artifact.

18. The method of claim 11, further comprising, before receiving the code identity endorsement, transmitting instructions for storing the code identity artifact on an external system.

19. The method of claim 18, wherein the code identity artifact is stored on a public ledger on the external system.

20. A computing system for implementing a confidential code execution environment for a code transparency service, the computing system comprising:
a set of processors; and
a set of storage devices storing:
a ledger;
an auditor module comprising a code review machine learning model; and
instructions that, when executed, cause the set of processors to:
receive code data from a producer;
store a code identity artifact comprising the code data on a ledger, wherein the ledger is updatable by an authorized party;
review the code data using the code review machine learning model;
receive a code identity endorsement from the auditor module for the stored code identity artifact; and
store a code identity endorsement artifact on the ledger based on the received endorsement from the auditor module, wherein the code identity endorsement artifact is associated with the stored code identity artifact.
